(19) United States
(12) Patent Application Publication
(10) Pub. No.: US 2011/0167092 A1
(43) Pub. Date: Jul. 7, 2011

(54) IMAGE CACHING IN A HANDHELD DEVICE

(76) Inventors: Baskaran Subramaniam, San Jose, CA (US); Peter Wagner, Sunnyvale, CA (US)

(21) Appl. No.: 12/693,406

(22) Filed: Jan. 25, 2010

Related U.S. Application Data
(60) Provisional application No. 61/292,770, filed on Jan. 6, 2010.

(51) Int. Cl. G06F 17/30; G06F 15/16

(52) U.S. Cl. 707/804; 709/219; 707/E17.005; 707/E17.009

(57) ABSTRACT

Methods, apparatuses, and systems for image caching are described. Exemplary methods, apparatuses, and systems generate and maintain a single database of metadata for media files received from multiple sources with disparate formats and transmit the database entries to a host device in response to receiving a request from the host device for the metadata.

### CROSS-REFERENCE TO RELATED APPLICATIONS

This application claims the benefit of U.S. Provisional Application No. 61/292,770, filed Jan. 6, 2010, which is hereby incorporated by reference in its entirety.

### FIELD

The various embodiments described herein relate to apparatuses, systems, and methods to generate and maintain a database of metadata for media files received from multiple sources and transmit the database to the host in response to receiving a request from a host device for the database.

### BACKGROUND

Digital media files, such as pictures and video, can be transferred from the device that captured or otherwise obtained the media files (e.g., a camera) to another device for manipulation, storage, publishing, printing, etc. (e.g., a computer). Additionally, the transfer may involve an intermediate storage device to enable a user to remove the media files from a camera prior to the user transferring the media files to a computer (e.g., to free up memory in a camera before the user has access to the computer). Increases in memory size in cameras and other portable electronic devices, and corresponding increases in the number of media files stored and transferred, have led to slower transfer times of the media files and their metadata.

### SUMMARY OF THE DESCRIPTION

Exemplary embodiments of methods, apparatuses, and systems to generate and maintain, in a handheld device, a single database of metadata for media files received from multiple sources with disparate formats and to transmit the database entries to a host device in response to receiving a request from the host device for the metadata.

### BRIEF DESCRIPTION OF THE DRAWINGS

The present invention is illustrated by way of example and not limitation in the figures of the accompanying drawings, in which like references indicate similar elements, and in which:

FIG. 1 illustrates an exemplary handheld device that can perform image caching;

FIG. 2 illustrates, in block diagram form, an exemplary a handheld device that can perform image caching; and

FIG. 3 is a flow chart that illustrates an exemplary method of image caching.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

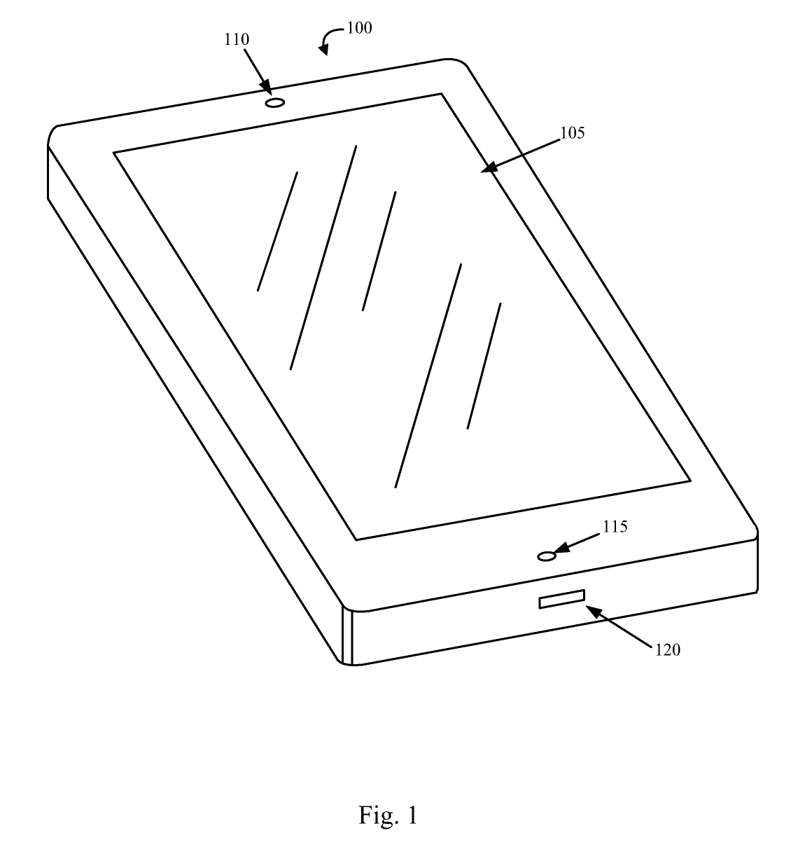

FIG. 1 illustrates an exemplary handheld device 100 that can perform image caching according to an embodiment. The handheld device 100 includes a display 105 which occupies a substantial portion (e.g. more than 75%) of one surface of the handheld device 100. The handheld device 100 may have a substantially rectangular frame on which is disposed the display 105. The display 105 may include an integrated touch input panel, such as a multi-touch input panel. The touch input panel may be integrated with the display 105 such that the display 105 and the touch input panel are overlapping and registered to each other.

For one embodiment, the handheld device 100 optionally includes a camera 110. The camera 110 may be incorporated in one of the sides of the rectangular frame that surrounds the display 105. Alternatively, a camera 110 is incorporated on another side of the handheld device—e.g., on the opposite side of the handheld device 100 as the display 105. The handheld device 100 may also include one or more sensors, which may be, in one embodiment, a proximity sensor or an ambient light sensor or other sensors or a combination of such sensors. For one embodiment, one or more of these sensors are incorporated with the camera 110.

A speaker 115 may also be disposed on or set within a surface of the handheld device 100. Although the speaker 115 is illustrated as being incorporated in one of the sides of the rectangular frame that surrounds the display 105, it may be incorporated on another side of the handheld device—e.g., on the opposite side of the handheld device 100 as the display 105.

Additionally, one or more connector sockets 120 may also be disposed on or set within a surface of the handheld device 100. Exemplary connector sockets 120 include Universal Serial Bus (“USB”), FireWire, or other interface to connect the handheld device 100 with another device, external component, or a network.

The handheld device 100 may include a wireless transceiver (not shown), which operates using Bluetooth, infrared, IEEE 802.11, cellular (e.g., 1G, 2G, 3G, 4G), or another wireless protocol to connect the handheld device 100 with another device, external component, or a network. Additionally, the handheld device 100 may also optionally include a microphone (not shown) or socket interface 120 to receive a microphone.

In certain embodiments, the handheld device 100 may be implemented in a small form-factor which resembles a handheld computer having a tablet-like input device which may be a multi-touch input panel device which is integrated with, e.g., a liquid crystal display. The handheld device 100 shown in FIG. 1 may be implemented in a handheld form-factor which has a size such that it may be held in one hand of a user. Examples of such devices are provided in U.S. patent application Ser. No. 11/586,862, filed Oct. 24, 2006, and entitled “AUTOMATED RESPONSE TO AND SENSING OF USER ACTIVITY IN PORTABLE DEVICES,” which is assigned to the same assignee as the instant application. In at least one embodiment, the handheld device 100 may have a size in a first dimension of less than about 10 inches and a size in a second dimension of less than about 7.5 inches and a size in a third dimension of less than about 1.5 inches. In an alternative embodiment, the handheld device 100 may have a size in a first dimension of less than about 5 inches and a size in a second dimension of less than about 3 inches and a size in a third dimension of less than about 0.75 inches. Each of these dimensions may be an axis of one of the axes in an X, Y, Z coordinate space.

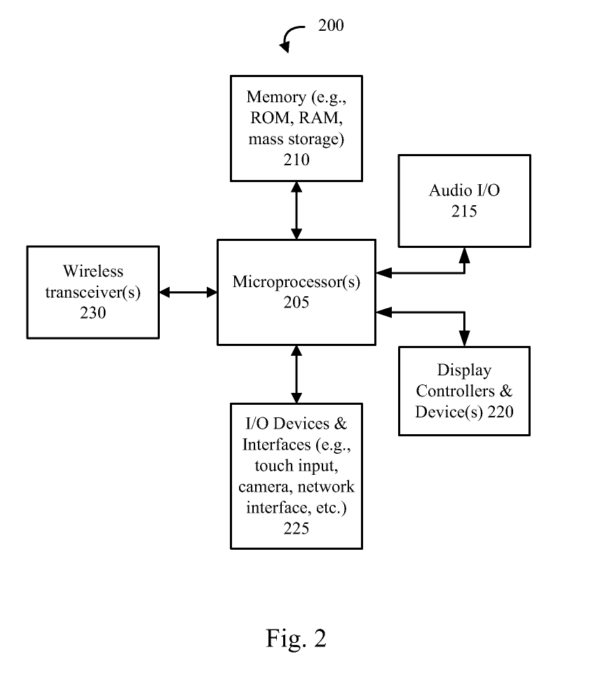

FIG. 2 illustrates, in block diagram form, an exemplary data processing system 200 for the handheld device 100 that can perform image caching according to an embodiment. Data processing system 200 may include one or more microprocessors 205 and connected system components (e.g., multiple connected chips) or the data processing system 200 may be a system on a chip.

The data processing system 200 includes memory 210 which is coupled to the microprocessor(s) 205. The memory 210 may be used for storing data, metadata, and programs for execution by the microprocessor(s) 205. The memory 210 may include one or more of volatile and non-volatile memories, such as Random Access Memory (“RAM”), Read Only Memory (“ROM”), Flash, Phase Change Memory (“PCM”), or other types of data storage.

The data processing system 200 also includes an audio input/output subsystem 215 which may include a microphone and/or a speaker for, for example, playing back music, providing telephone or voice/video chat functionality through the speaker and microphone, etc.

A display controller and display device 220 provides a visual user interface for the user; this user interface may include a graphical user interface which, for example, is similar to that shown on a Macintosh computer when running Mac OS operating system software or an iPhone when running iPhone OS operating system software.

System 200 also includes one or more wireless transceivers 230, such as an IEEE 802.11 transceiver, an infrared transceiver, a Bluetooth transceiver, a wireless cellular telephony transceiver (e.g., 1G, 2G, 3G, 4G), or another wireless protocol to connect the handheld device 100 with another device, external component, or a network.

It will be appreciated that one or more buses, may be used to interconnect the various components shown in FIG. 2.

The data processing system 200 may be a handheld personal computer, tablet-style device, a personal digital assistant (PDA), a cellular telephone with PDA-like functionality, such as an iPhone, a Wi-Fi based telephone, a handheld computer which includes a cellular telephone, a media player, such as an iPod, an entertainment system, such as a iPod touch, or devices which combine aspects or functions of these devices, such as a media player combined with a PDA and a cellular telephone in one device. In other embodiments, the data processing system 200 may be a network computer or an embedded processing device within another device or consumer electronic product.

The system 200 also includes one or more input or output (“I/O”) devices and interfaces 225 which are provided to allow a user to provide input to, receive output from, and otherwise transfer data to and from the system. These I/O devices may include a mouse, keypad or a keyboard, a touch panel or a multi-touch input panel, camera, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 200. The I/O devices and interfaces 225 may include a connector for a dock or a connector for a USB interface, FireWire, etc. to connect the system 200 with another device, external component, or a network.

It will be appreciated that additional components, not shown, may also be part of the system 200, and, in certain embodiments, fewer components than that shown in FIG. 2 may also be used in a data processing system 200. It will be apparent from this description that aspects of the inventions may be embodied, at least in part, in software. That is, the computer-implemented methods may be carried out in a computer system or other data processing system in response to its processor or processing system executing sequences of instructions contained in a memory, such as memory 210 or other machine-readable storage medium. The software may further be transmitted or received over a network (not shown) via a network interface device 225. In various embodiments, hardwired circuitry may be used in combination with the software instructions to implement the present embodiments. Thus, the techniques are not limited to any specific combination of hardware circuitry and software, nor to any particular source for the instructions executed by the data processing system 200.

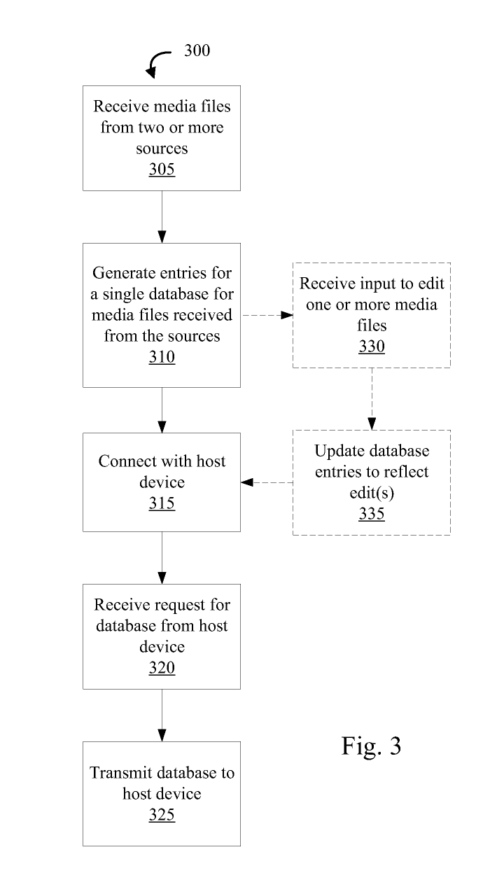

FIG. 3 is a flow chart that illustrates an exemplary method 300 of image caching. At block 305, the data processing system 200 receives media files from two or more sources. The two or more sources may include, for example, an internal camera 110/225, a networked device (e.g., downloaded over a LAN or the Internet), an external camera, a memory stick removed from another electronic device, a USB flash drive (keychain drive, thumb drive, or pen drive), or other portable storage device. The media files may be received via download over a network or discovered and requested from an attached device or a wired or wirelessly connected device. For example, a USB device inserted into interface 120/225 could expose its file layout and allow for the data processing system 200 to explore and copy files therein. Alternatively, files may be accessed in an object-oriented view without exposing the file layout, e.g., via the Picture Transfer Protocol (“PTP”).

At block 310, upon or during receipt the media files, the data processing system 200 generates metadata entries for a database. For one embodiment, the data processing system 200 parses each media file to obtain metadata included with the media file. The data processing system 200 receives media files from disparate sources. As a result, each media file may include and format the metadata differently. For one embodiment, parsing each media file, therefore, includes determining the type or location of each metadata field so that a single database is maintained for the varying media files. For example, the data processing system 200 may determine the format of the media file by examining the file extension or a portion of the file to indicate the file type or format. There are a variety of formats and corresponding file extensions, for example (and not limited to) “.gif,” “.jpeg,” “.mpeg.” Once the format is determined, the data processing system 200 may determine the location of metadata according to the corresponding standard/protocol. If the format of the media file cannot be determined or recognized, or if the processing system 200 does not have a priori knowledge of a protocol or standard layout for the metadata in a particular format, the processing system 200 probes the file system of the source device or issues an appropriate protocol command used by the source device. If probing the file system of the source device or appropriate protocol command does not return a value, for one embodiment, the processing system 200 records an indication that the value is not known in the corresponding database entry.

For example, if the media file is determined to be a Joint Photographic Experts Group (“JPEG”) image file generated from a digital camera, then the data processing system 200 would attempt to extract a “photo capture date” embedded in the image file at a known location. Alternatively, if the media file is determined to be a Portable Network Graphics (“PNG”) file, which does not have an embedded date, then the processing system 200 would further probe the file system of the connected device (in this example, the digital camera) or issue an appropriate protocol command used by the connected device (e.g., based upon the digital camera's manufacture/software type) to determine a file creation date that would act as the rough equivalent of the capture data of a camera JPEG. By determining the type of file first, only one method of finding the date, or other type of metadata, needs to be tried.

Sometimes, several files form a common group where information about one file in the group pertains to other files in the group as well. These groupings of files are identified during data extraction. The current system groups files that have the same “base” filename but different extensions. For example, some digital cameras will simultaneously create both a raw file and a JPEG file for each picture that the photographer shoots. The files have the same base name (e.g., “IMG_{—}1234”) but two different extensions (e.g., “.jpg” and “.CR2”). The system 200 analyzes the different files in a single group and determines which file(s) will yield the metadata with the least amount of work/probing, and what metadata can be shared across the family of files. For example, if the system 200 recognizes a JPEG file, it can get the capture time from that file and skip that task for the CR2 by assuming the two files have the same value.

Exemplary metadata fields include a size of the media file (compressed or otherwise), a format or type of the media file, a format of a thumbnail for the media file, a size of the thumbnail, a width (e.g., in pixels) of the thumbnail, a height (e.g., in pixels) of the thumbnail, a width (e.g., in pixels) of the media file, a height (e.g., in pixels) of the media file, a depth (e.g., in bits) of the media file, camera settings (e.g., aperture, shutter speed, etc.), a filename, a capture date, a name of the device that captured the media file, a modification date, a file system path to the original file, a file system path to the file that contains the thumbnail, a byte offset of the first byte of the thumbnail data, file names of other files related to this file, a desired orientation of the media file (e.g., rotated by 90 degrees), etc.

For one embodiment, one or more of the disparate sources may include a metadata database along with any media files transferred to the data processing system 200. Accordingly, the data processing system 200 parses the received database(s) to generate entries for its own database. If the received database is in the same format as the database maintained by the data processing system 200, the entries of the received database may be merged with the database maintained by the data processing system 200. Alternatively, the data processing system 200 parses individual media files to obtain the relevant metadata.

The generation of metadata entries by the data processing system 200 is done automatically in response to receiving the media files and in anticipation of a request for the metadata from a host device. In other words, the data processing system 200 begins generating metadata entries prior to receiving a request for metadata or the database. For one embodiment, the database is a Structured Query Language (“SQL”) database. Alternatively, the database is maintained according to another database computer language/protocol.

At block 315, the data processing system 200 connects with a host device. This connection may be wired or wireless. For one embodiment, the host device is a personal computer. Alternatively, the host device is a server or other network-based device.

At block 320, the data processing system 200 receives a request from the host device for the database or database entries. For one embodiment, the request is a single request for a list of all media files stored/available within the data processing system 200 and their corresponding metadata (e.g., stored in the memory 210). The request may be formatted according to PTP or other transfer protocol for media files and establish a master-slave relationship for the transfer of the metadata and media files from the data processing system (slave) to the host device (master). As described above, the generation of database entries occurs in anticipation of the request received at block 320—i.e., the database has been generated or the data processing system 200 has at least begun generating database entries prior to receipt of the request.

At block 325, the data processing system 200 transmits the database, or contents thereof, to the host device in response to the host device's request. For one embodiment, the metadata is transferred and/or maintained in the database according to PTP or other transfer protocol for media files to expedite a corresponding request according to that protocol.

At block 330, the data processing system 200 optionally receives input from a user to edit one or more media files and executes the changes. Exemplary edit inputs may include zooming, rotating, adjusting color, contrast, brightness, panning, adding or removing audio, deleting a media file, or otherwise altering the media files. At block 335, the database entries for the edited media files are updated to reflect the edits in anticipation of the described host request.

In the foregoing specification, the invention has been described with reference to specific exemplary embodiments thereof. It will be evident that various modifications may be made thereto without departing from the broader spirit and scope of the invention as set forth in the following claims. An article of manufacture may be used to store program code providing at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention. The specification and drawings are, accordingly, to be regarded in an illustrative sense rather than a restrictive sense.

What is claimed is:

1. A handheld device comprising:
a memory to store media files acquired from a plurality of sources; and
a processor coupled to the memory, wherein the processor executes instructions that cause the processor to
automatically generate database entries in a database in the memory in response to acquisition of the media files, the entries including metadata corresponding to the media files from the plurality of sources, and
transmit the database to a host device in response to a request received from the host device, wherein the database has been generated prior to receipt of the request.

2. The handheld device of claim 1, wherein the processor generates a database entry for a media file upon acquisition of the media file.

3. The handheld device of claim 1, wherein the processor receives input to edit a media file stored in the memory and updates the database according to the edit.

4. The handheld device of claim 1, wherein the request is a single call for information regarding all media files stored in the memory and available to be downloaded by the host device.

5. The handheld device of claim 1, wherein the plurality of sources include one or more external cameras, external mass storage devices, network-based devices, or an internal camera.

6. The handheld device of claim 1, wherein the media files from the plurality of sources have a plurality of different formats.

7. A handheld device comprising:
a memory to store media files acquired from a plurality of external media sources; and
a processor coupled to the memory, wherein the processor executes instructions that cause the processor to
automatically generate database entries in a database in the memory in response to acquisition of the media files, the entries including metadata corresponding to the media files, and
transmit the database to a host device in response to a request received from the host device, wherein the database has been generated prior to receipt of the request.

8. The handheld device of claim 7, wherein the plurality of external sources include one or more external cameras, external mass storage devices, or network-based devices and wherein the media files from two or more of the external sources are of different formats from one another.

9. The handheld device of claim 7, wherein the request is a single call for information regarding all media files stored in the memory and available to be downloaded by the host device.

10. A computer-implemented method of caching media files in a handheld device, the method comprising:
storing media files acquired from a plurality of sources in a memory of the handheld device;
automatically generating database entries in a database in the memory in response to acquisition of the media files, the entries including metadata corresponding to the media files from the plurality of sources; and
transmitting the database to a host device in response to a request received from the host device, wherein the database has been generated prior to receipt of the request.

11. The computer-implemented method of claim 10, wherein the handheld device generates a database entry for a media file upon acquisition of the media file.

12. The computer-implemented method of claim 10, further comprising:
receiving input to edit a media file stored in the memory; and
updating the database according to the edit.

13. The computer-implemented method of claim 10, wherein the request is a single call for information regarding all media files stored in the memory and available to be downloaded by the host device.

14. The computer-implemented method of claim 10, wherein the plurality of sources include one or more external cameras, external mass storage devices, network-based devices, or an internal camera.

15. The computer-implemented method of claim 10, wherein the media files from the plurality of sources have a plurality of different formats.

16. A computer-implemented method of caching media files in a handheld device, the method comprising:
storing media files acquired from a plurality of external media sources in a memory of the handheld device;
automatically generating database entries in a database in the memory in response to acquisition of the media files, the entries including metadata corresponding to the media files; and
transmitting the database to a host device in response to a request received from the host device, wherein the database has been generated prior to receipt of the request.

17. The computer-implemented method of claim 16, wherein the plurality of external sources include one or more external cameras, external mass storage devices, or network-based devices and wherein the media files from two or more of the external sources are of different formats from one another.

18. The computer-implemented method of claim 16, wherein the request is a single call for information regarding all media files stored in the memory and available to be downloaded by the host device.

19. A machine-readable storage medium storing instructions that, when executed, cause a handheld device to perform a method comprising:
storing media files acquired from a plurality of sources in a memory of the handheld device;
automatically generating database entries in a database in the memory in response to acquisition of the media files, the entries including metadata corresponding to the media files from the plurality of sources; and
transmitting the database to a host device in response to a request received from the host device, wherein the database has been generated prior to receipt of the request.

20. The machine-readable storage medium of claim 19, wherein the handheld device generates a database entry for a media file upon acquisition of the media file.

21. The machine-readable storage medium of claim 19, further comprising:
receiving input to edit a media file stored in the memory; and
updating the database according to the edit.

22. The machine-readable storage medium of claim 19, wherein the request is a single call for information regarding all media files stored in the memory and available to be downloaded by the host device.

23. The machine-readable storage medium of claim 19, wherein the plurality of sources include one or more external cameras, external mass storage devices, network-based devices, or an internal camera.

24. The machine-readable storage medium of claim 19, wherein the media files from the plurality of sources have a plurality of different formats.

25. A machine-readable storage medium storing instructions that, when executed, cause a handheld device to perform a method comprising:
storing media files acquired from a plurality of external media sources in a memory of the handheld device;
automatically generating database entries in a database in the memory in response to acquisition of the media files, the entries including metadata corresponding to the media files; and
transmitting the database to a host device in response to a request received from the host device, wherein the database has been generated prior to receipt of the request.

26. The machine-readable storage medium of claim 25, wherein the plurality of external sources include one or more external cameras, external mass storage devices, or network-based devices and wherein the media files from two or more of the external sources are of different formats from one another.

27. The machine-readable storage medium of claim 25, wherein the request is a single call for information regarding all media files stored in the memory and available to be downloaded by the host device.
